(19) United States
(12) Patent Application Publication
(10) Pub. No.: US 2025/0298445 A1
(43) Pub. Date: Sep. 25, 2025

(54) DOOR-MOUNTED LAPTOP BATTERY WITH AUTO-DISCONNECT

(71) Applicant: Lenovo (Singapore) Pte. Ltd., Singapore (SG)

(72) Inventors: Alden Rose, Durham, NC (US); Dhruvi Suresh Fulfagar, Concord, NC (US); Sara Nicole Weir, Raleigh, NC (US)

(21) Appl. No.: 18/615,737

(22) Filed: Mar. 25, 2024

(51) Int. Cl. G06F 1/16

(52) U.S. Cl. CPC G06F 1/1677

(57) ABSTRACT

An electronic device includes a chassis containing electrically powered circuitry and a chassis cavity for supporting a battery having a set of battery contacts. The chassis also include a latch and a circuitry connector having circuitry contacts to electrically connect to the battery contacts and provide power to the electrically powered circuitry. An access panel is coupled to the chassis by a hinge to selectively cover and expose the chassis cavity. The access panel has walls configured to secure and register the battery to cause the battery contacts to engage the circuitry contacts with the access panel in a closed position secured by the latch.

### BACKGROUND

The current laptop battery replacement experience is difficult and unsafe for the average user. Most internal batteries are mylar wrapped with a soft shell. Removal of such batteries can involve the use of tools to remove access panels or covers from a laptop chassis. The batteries are prone to damage when exposed to fasteners used to retain panels or covers and the tools used to remove the fasteners. Current designs require the user to unscrew multiple screws to gain access to and to remove the battery. The removal process can also be difficult for many users, as well as causing potential safety or functional issues if users lose a screw or misplace a screw in the chassis.

Gaining access to and removing the battery can also expose sensitive components in the device, opening the components up to damage. It can be difficult to remove the battery from the chassis, as the battery can be difficult to grip, often requiring the user to insert a tool under the battery to pry it out which could puncture the battery or damage components around the battery. Some batteries require disconnecting and reconnecting a delicate cable between the battery and system board. If this connector is damaged, the system board may also be damaged.

Currently the safest and easiest laptop batteries to replace have a hard shell resulting in significant tradeoffs in terms of device thickness, cost, weight and battery capacity.

### SUMMARY

An electronic device includes a chassis containing electrically powered circuitry and a chassis cavity for supporting a battery having a set of battery contacts. The chassis also include a latch and a circuitry connector having circuitry contacts to electrically connect to the battery contacts and provide power to the electrically powered circuitry. An access panel is coupled to the chassis by a hinge to selectively cover and expose the chassis cavity. The access panel has walls configured to secure and register the battery to cause the battery contacts to engage the circuitry contacts with the access panel in a closed position secured by the latch.

### BRIEF DESCRIPTION OF THE DRAWINGS

FIG. 1 is a perspective view of a back of an electronic device having an access panel to access a battery held by the access panel according to an example embodiment.

FIG. 2 is a perspective view of the electronic device of FIG. 1 illustrating release of the access panel by operation of a latch according to an example embodiment.

FIG. 3 is a perspective view of the electronic device of FIG. 1 illustrating further rotation of the access panel to expose a chassis cavity and battery according to an example embodiment.

FIG. 4A is a side block diagram view of a portion of battery and wall of the access panel showing respective angled edges chamfered walls to register the battery according to an example embodiment.

FIG. 4B is a side block diagram view of an alternative portion of a battery having a rectangular cross section fitting into an “L” shaped wall of the access panel according to an example embodiment.

FIG. 5 is a perspective view of a separated push pin set of contacts according to an example embodiment.

FIG. 6 is a perspective view of the push pin set of contacts shown in an engaged, loaded, position caused by rotation of the access panel to a closed position according to an example embodiment.

FIG. 7 is a block diagram side view illustrating operation of a latch device according to an example embodiment.

FIG. 8 is a block schematic diagram of a computer system to implement one or more electronic devices.

### DETAILED DESCRIPTION

In the following description, reference is made to the accompanying drawings that form a part hereof, and in which is shown by way of illustration specific embodiments which may be practiced. These embodiments are described in sufficient detail to enable those skilled in the art to practice the invention, and it is to be understood that other embodiments may be utilized and that structural, logical and electrical changes may be made without departing from the scope of the present invention. The following description of example embodiments is, therefore, not to be taken in a limited sense, and the scope of the present invention is defined by the appended claims.

An electronic device includes a hinged “D” shaped battery access panel with a battery mounted to an underside of the panel. The panel has structural supports that create a housing for the battery to hold the battery in place while the panel is closed. The structural supports cause the battery to snap securely into place to electrically connect the battery to electronic circuitry within the electronic device in response to closing of the panel. The battery may be a mylar wrapped device internal battery that does not have a hard-shell covering.

The mounting position of the battery results in automatic electrical disconnection from a device power connector in response to opening of the door. The battery is automatically disconnected from the device power connector in response to opening of the door due to an angle of rotation of the door about the hinge causing the battery power connector contacts to move away from the device power connector contacts. Closing of the door causes the respective connector contacts to align and electrical connect.

In one example, hand operated latches may be used to latch and open the access panel without the use of tools, enabling much safer battery access and replacement as no tools or screws are needed. In further examples, operation of the latch to open the panel causes the panel to separate from the device, making it easy to manually open the panel to obtain access to the battery without the user having to use tools, or pry the panel by sticking fingers in little gaps to grip the panel or battery. The battery makes it safe to replace as the panel and battery are clear of any wires, connectors or other components during the removal process. The battery can be accessed and replaced without the risk of potential damage. Since the battery is automatically disconnected when the panel is opened, the user does not need to interact with a battery that is still electrically connected and running current. The lack of running current makes the battery replacement process much safer.

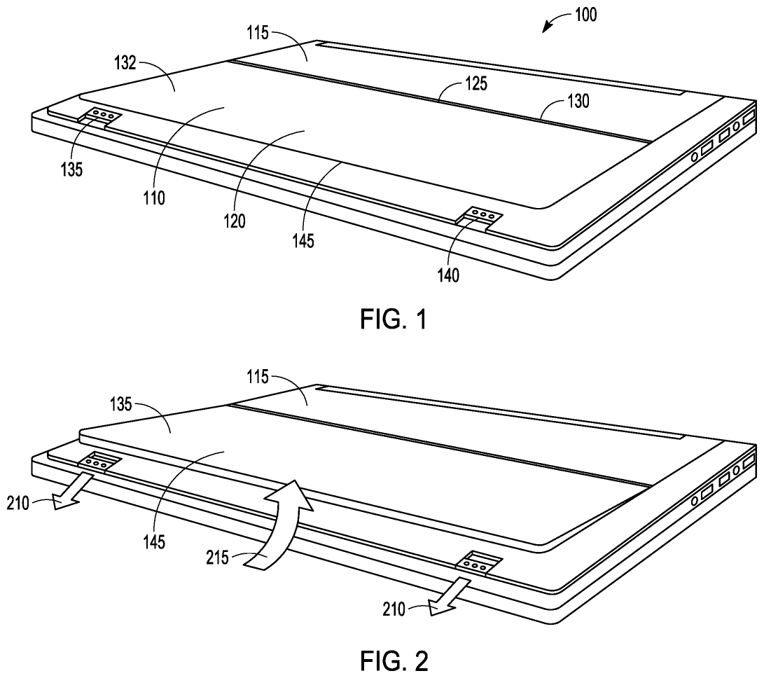

FIG. 1 is a perspective view of a back of an electronic device 100 having an access panel 110 that is coupled to a chassis 115 of the electronic device 100 via a hinge 125 located on a hinged edge 130 of the access panel 110. A top side 132 of access panel 110 is shown. A hinge 125 may be formed of a compliant material rotatably coupling the hinged edge 130 or side of the access panel 110 to the chassis 115. Other types of hinges, such as common butt hinges or concealed hinges found on doors may be used in further examples.

The access panel 110 is secured to the electronic device 100 chassis 115 via at least one latch 135. A second latch 140, along with latch 135 is shown adjacent to a latch edge 145 of the access panel 110 opposite the hinged edge 130 in one example but may be positioned on other sides in further examples. Two of latch 135 are shown. In further examples, one or more latches may take any form that is user friendly, such as a piece of material with a pivot-point that rotates over the access panel 110 to secure it.

FIG. 2 is a perspective view of electronic device 100 illustrating release of the access panel 110 by operation of latch 135. Arrows 210 show operation of the of latch 135 moving away from the latch edge 145 of the access panel 110 to release the access panel 110 an allow further rotation of the access panel 110 about the hinge 125 as illustrated by arrow 215.

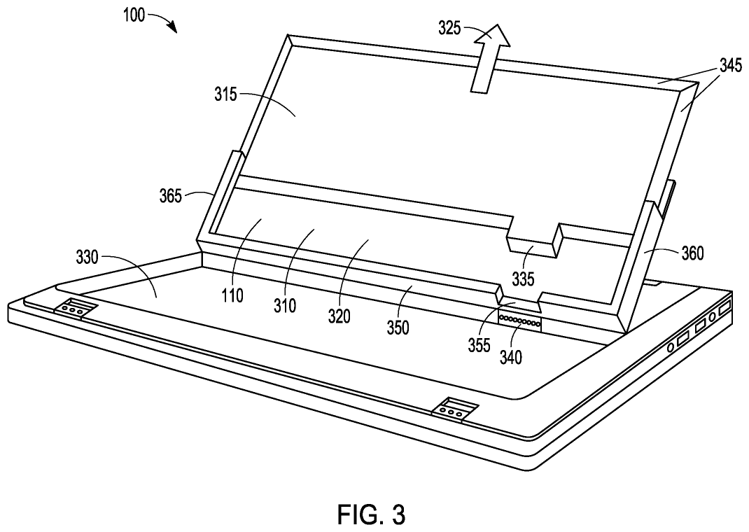

FIG. 3 is a perspective view of electronic device 100 illustrating further rotation of the access panel 110 to expose a chassis cavity 310 having a volume suitable for supporting a battery 315. Battery 315 is shown being removed from a bottom side 320 of the access panel 110 as illustrated by arrow 325. In one example, electronic device 100 may be a laptop computer, tablet computer, cellular telephone, or other device containing electrically powered circuitry. The electrically powered circuitry need not be exposed by accessing the chassis cavity 310.

Battery 315 has battery contacts 335 that will electrically couple to circuitry contacts 340 in response to closing of the access panel 110. The access panel 110 operates to selectively cover and expose the chassis cavity while making electrical contact with the battery 315 in the closed position.

In one example, the battery 315 has edges 345 that are angled or chamfered to mate with one or more walls extending from the bottom side 320 of the access panel 110. A first inverse chamfered wall 350 extends along the hinged edge 130 and includes an opening 355 positioned to allow passage of the battery contacts 335 that extend a distance from one edge of the battery 315. The opening 355 enables the battery contacts 335 to align with and engage with the circuitry contacts 340, essentially registering the battery 315 in the proper position when the access panel 110 is closed. In further examples, the walls of the access panel 110 and edges of the battery 315 may be keyed such as by tongue and groove arrangements or any other means of enabling the battery 315 to slide into and be retained by the access panel 110 to enable contact alignment and replacement in a convenient manner.

One or more side inverse chamfered walls 360, 365 may be used to aid in securing and registering the battery 315 and cause the battery contacts 335 to engage the circuitry contacts 340 with the access panel 110 in a closed position secured by the spring latch 135. In one example, the battery 315 comprises a mylar cover shaped to fit the chassis cavity and the inverse chamfered walls 350, 360, 365. In further examples, the walls may be “L” shaped, with the battery 315 shaped to register with the shape of the walls.

In one example, the access panel 110 is rectangular in shape and the inverse chamfered walls 350, 360, 365 extend along the hinged edge 130 of the access panel 110 and partially along two sides of the access panel 110 extending toward latch edge 145 of the access panel 110.

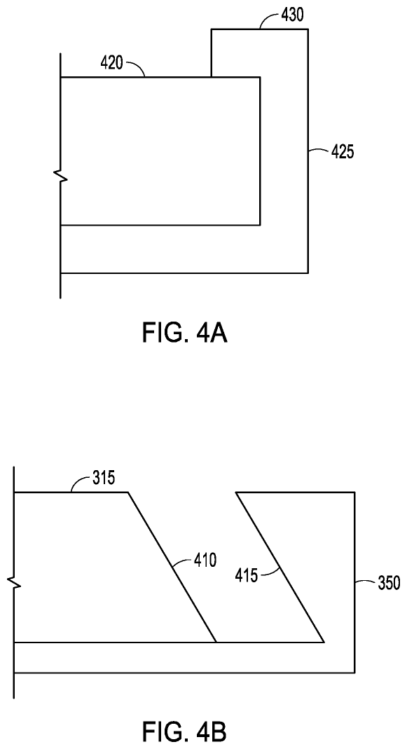

FIG. 4A is a side block diagram view of a portion of the battery 315 and wall 350 of the access panel 110 showing respective angled edges 410, 415 and chamfered wall to register the battery 315 in position to ensure electrical contact is made upon closing the access panel 110.

FIG. 4B is a side block diagram view of an alternative portion of a battery 420 having a rectangular cross section fitting into an “L” shaped wall 425 of the access panel 110. Wall 425 includes a portion 430 forming a base of the “L” shape that overlaps and holds the battery 420 in position. Other mating type structures may be used on various batteries and walls to register and retain the battery to the access panel 110 in further examples.

In one example, the battery contacts 335 and circuitry contacts 340 are surface contacts that electrically engage based on surface pressure. Such contacts may be flexible to create consistent and repeatable electrical contact with repeated opening and closing of the access panel 110

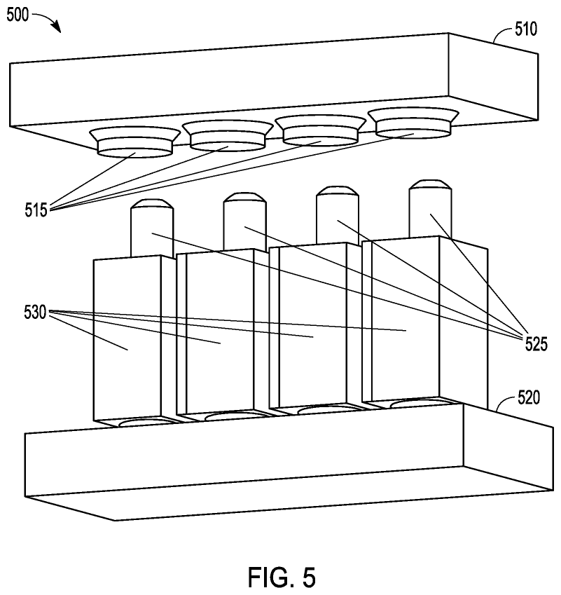

FIG. 5 is a perspective view of a separated push pin set of contacts 500. In one example, battery contacts 510 include multiple metal surface contacts 515. Circuitry contacts 520 include push pins 525 that are spring loaded via spring cannisters 530. In further examples, the battery 315 may include the push pins 525 with the circuitry contacts 335 comprising the surface contacts 515. As the access panel 110 is rotated into a closed position, the push pins 525 start to engage the surface contacts 515. When latched in a closed position, the push pins 525 are spring loaded into secure and conductive contact with the surface contacts 515. In contrast, as the access panel is opened, the push pines 525 and surface contacts 515 are separated and no longer in electrical contact, preferable prior to the access panel 110 being opened far enough to enable the user to access the cavity 330, reducing chances of electrical shock.

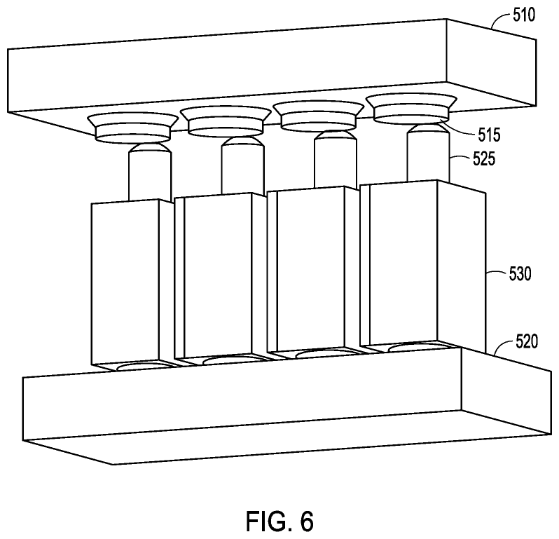

FIG. 6 is a perspective view of the push pin set of contacts 500, also referred to as pogo contacts, shown in an engaged, loaded, position caused by rotation of the access panel 110 to a closed position. The push pins 525 have been pushed into their respective spring canisters 530, creating a force sufficient to press the pins into solid electrical contact with surface contacts 515. Surface contacts 515 on the battery 315 provide an electrical connection to corresponding pin connectors in the closed position.

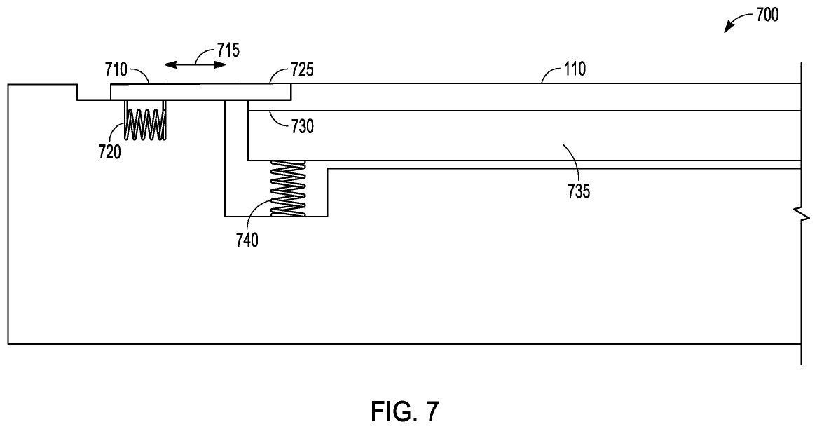

FIG. 7 is a block diagram side view illustrating operation of a latch device 700. In one example, latch device 700 may include a spring loaded slide plate 710 that moves laterally as indicated by arrow 715. A spring 720 may be coupled to bias the slide plate 710 into a spring latched closed position in which a latching portion 725 overlaps a latch engaging portion 730 of a battery 735. In one example, on moving the slide plate an open position, towards the left, the latching portion no longer overlaps the latch engaging portion 730 of the battery 735.

An opening spring 740 is supported by the chassis of the device and pushes the latch engaging portion 730 upwards, out of the cavity, to enable further opening of the access panel 110 and battery 735 to remove or replace the battery 735. Once done, and the access panel the closed, compressing opening spring 740, the slide plate 710 may be moved back towards a closed position.

With the use of spring 720, the slide plate 710 may need to held in the left position while closing the access panel 110. In further examples, ramp features may be used to move the slide plate 710 while closing the access panel 110. Other types of latching mechanisms that provide retaining and opening functions may be used in further examples.

In one example, to aid in opening the access panel while a spring latch is moved to an open position, the spring latch moves against a chamfered edge to slightly raise access panel 110 and battery to enable further opening to a position from which battery can be removed.

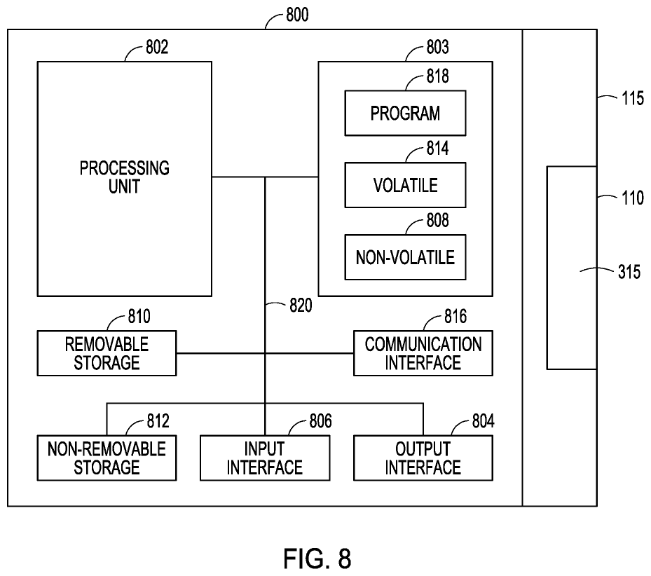

FIG. 8 is a block schematic diagram of a computer system 800 showing components of an example, electronic device 100, such as a laptop computer or other device having electronic circuitry powered by a battery. All components need not be used in various embodiments. Battery 315 is illustrated coupled to the chassis 115 of the computer system 800 and accessible via the access panel 110.

One example computing device in the form of a computer 800 may include a processing unit 802, memory 803, removable storage 810, and non-removable storage 812. Although the example computing device is illustrated and described as computer 800, the computing device may be in different forms in different embodiments. For example, the computing device may instead be a smartphone, a tablet, smartwatch, smart storage device (SSD), or other computing device including the same or similar elements as illustrated and described with regard to FIG. 8. Devices, such as smartphones, tablets, and smartwatches, are generally collectively referred to as mobile devices or user equipment.

Although the various data storage elements are illustrated as part of the computer 800, the storage may also or alternatively include cloud-based storage accessible via a network, such as the Internet or server-based storage. Note also that an SSD may include a processor on which the parser may be run, allowing transfer of parsed, filtered data through I/O channels between the SSD and main memory.

Memory 803 may include volatile memory 814 and non-volatile memory 808. Computer 800 may include—or have access to a computing environment that includes—a variety of computer-readable media, such as volatile memory 814 and non-volatile memory 808, removable storage 810 and non-removable storage 812. Computer storage includes random access memory (RAM), read only memory (ROM), erasable programmable read-only memory (EPROM) or electrically erasable programmable read-only memory (EEPROM), flash memory or other memory technologies, compact disc read-only memory (CD ROM), Digital Versatile Disks (DVD) or other optical disk storage, magnetic cassettes, magnetic tape, magnetic disk storage or other magnetic storage devices, or any other medium capable of storing computer-readable instructions.

Computer 800 may include or have access to a computing environment that includes input interface 806, output interface 804, and a communication interface 816. Output interface 804 may include a display device, such as a touchscreen, that also may serve as an input device. The input interface 806 may include one or more of a touchscreen, touchpad, mouse, keyboard, camera, one or more device-specific buttons, one or more sensors integrated within or coupled via wired or wireless data connections to the computer 800, and other input devices. The computer may operate in a networked environment using a communication connection to connect to one or more remote computers, such as database servers. The remote computer may include a personal computer (PC), server, router, network PC, a peer device or other common data flow network switch, or the like. The communication connection may include a Local Area Network (LAN), a Wide Area Network (WAN), cellular, Wi-Fi, Bluetooth, or other networks. According to one embodiment, the various components of computer 800 are connected with a system bus 820.

Computer-readable instructions stored on a computer-readable medium are executable by the processing unit 802 of the computer 800, such as a program 818. The program 818 in some embodiments comprises software to implement one or more methods described herein. A hard drive, CD-ROM, and RAM are some examples of articles including a non-transitory computer-readable medium such as a storage device. The terms computer-readable medium, machine readable medium, and storage device do not include carrier waves or signals to the extent carrier waves and signals are deemed too transitory. Storage can also include networked storage, such as a storage area network (SAN). Computer program 818 along with the workspace manager 822 may be used to cause processing unit 802 to perform one or more methods or algorithms described herein.

### Examples

1. An electronic device includes a chassis containing electrically powered circuitry and a chassis cavity for supporting a battery having a set of battery contacts. The chassis also include a latch and a circuitry connector having circuitry contacts to electrically connect to the battery contacts and provide power to the electrically powered circuitry. An access panel is coupled to the chassis by a hinge to selectively cover and expose the chassis cavity. The access panel has walls configured to secure and register the battery to cause the battery contacts to engage the circuitry contacts with the access panel in a closed position secured by the latch.
2 The device of example 1 wherein walls include a first inverse chamfered wall along a hinged side of the access panel and includes an opening to allow the battery contacts to contact the circuitry contacts.
3. The device of any of examples 1-2 wherein the circuitry contacts comprise push-pin contacts.
4. The device of any of examples 1-3 wherein the battery includes a mylar cover shaped to fit the chassis cavity and the walls which are shaped to register the battery.
5. The device of any of examples 1-4 wherein the chassis cavity conceals the electrically powered circuitry within the chassis while the chassis cavity is exposed.
6. The device of any of examples 1-5 wherein hinge includes a compliant material rotatably coupling a hinged side of the access panel to the chassis.
7. The device of example 1 wherein the access panel is rectangular in shape and the walls extend along the hinged side of the access panel and partially along two sides of the access panel extending toward an opposite side of the access panel.
8. The device of example 7 wherein the opposite side of the access panel is configured to mate with the latch in a closed position.
9. The device of example 8 wherein the opposite side of the access panel includes a ramp to engage with the latch to separate the opposite side of the access panel from the chassis in response to activating the latch to unlatch and open the access panel.
10. The device of any of examples 1-9 wherein the access panel is rectangular in shape and the walls extend along the hinged side of the access panel and includes an opening to allow the battery contacts to contact the circuitry contacts, and wherein the walls extend partially along two sides of the access panel extending toward an opposite side of the access panel, and wherein the circuitry contacts comprise push-pin contacts such that opening the access panel disconnects the battery contacts from the circuitry contacts.
11 The device of any of examples 1-10 wherein the latch includes two spaced apart latches supported on the chassis opposite the hinge.
12. An electronic device includes a chassis containing electrically powered circuitry. The chassis includes a chassis cavity sized to contain a battery having a set of battery contacts, a spring latch, and a circuitry connector having circuitry contacts to electrically connect to the battery contacts and provide power to the electrically powered circuitry. An access panel is coupled to the chassis by a hinge to selectively cover and expose the chassis cavity. The access panel includes inverse chamfered walls to secure and register the battery and cause the battery contacts to engage the circuitry contacts with the access panel in a closed position secured by the spring latch.
13. The device of example 12 wherein the inverse chamfered walls include a first inverse chamfered wall along a hinged side of the access panel and includes an opening to allow the battery contacts to contact the circuitry contacts.
14. The device of any of examples 12-13 wherein the circuitry contacts include push-pin contacts.
15. The device of any of examples 12-14 wherein the battery includes a mylar cover shaped to fit the chassis cavity and the inverse chamfered walls.
16. The device of any of examples 12-15 wherein the chassis cavity conceals the electrically powered circuitry within the chassis while the chassis cavity is exposed.
17. The device of any of examples 12-16 wherein hinge includes a compliant material rotatably coupling a hinged side of the access panel to the chassis.
18. The device of any of examples 12-17 wherein the access panel is rectangular in shape and the inverse chamfered walls extend along a hinged side of the access panel and partially along two sides of the access panel extending toward an opposite side of the access panel.
19. The device of example 18 wherein the opposite side of the access panel is configured to mate with the spring latch in a closed position and wherein the opposite side of the access panel comprises a ramp to engage with the spring latch to separate the opposite side of the access panel from the chassis in response to activating the spring latch to unlatch and open the access panel.
20. The device of any of examples 12-19 wherein the access panel is rectangular in shape and the inverse chamfered walls extend along a hinged side of the access panel and includes an opening to allow the battery contacts to contact the circuitry contacts, and wherein the inverse chamfered wall extend partially along two sides of the access panel extending toward an opposite side of the access panel, and wherein the circuitry contacts comprise push-pin contacts such that opening the access panel disconnects the battery contacts from the circuitry contacts.

Although a few embodiments have been described in detail above, other modifications are possible. For example, the logic flows depicted in the figures do not require the particular order shown, or sequential order, to achieve desirable results. Other steps may be provided, or steps may be eliminated, from the described flows, and other components may be added to, or removed from, the described systems. Other embodiments may be within the scope of the following claims.

1. An electronic device comprising:
a chassis containing electrically powered circuitry, the chassis comprising:
a chassis cavity for supporting a battery having a set of battery contacts;
a latch; and
a circuitry connector having circuitry contacts to electrically connect to the battery contacts and provide power to the electrically powered circuitry; and
an access panel coupled to the chassis by a hinge to selectively cover and expose the chassis cavity, the access panel comprising walls configured to secure and register the battery to cause the battery contacts to engage the circuitry contacts with the access panel in a closed position secured by the latch.

2. The device of claim 1 wherein walls include a first inverse chamfered wall along a hinged side of the access panel and includes an opening to allow the battery contacts to contact the circuitry contacts.

3. The device of claim 1 wherein the circuitry contacts comprise push-pin contacts.

4. The device of claim 1 wherein the battery comprises a mylar cover shaped to fit the chassis cavity and the walls which are shaped to register the battery.

5. The device of claim 1 wherein the chassis cavity conceals the electrically powered circuitry within the chassis while the chassis cavity is exposed.

6. The device of claim 1 wherein hinge comprises a compliant material rotatably coupling a hinged side of the access panel to the chassis.

7. The device of claim 1 wherein the access panel is rectangular in shape and the walls extend along the hinged side of the access panel and partially along two sides of the access panel extending toward an opposite side of the access panel.

8. The device of claim 7 wherein the opposite side of the access panel is configured to mate with the latch in a closed position.

9. The device of claim 8 wherein the opposite side of the access panel comprises a ramp to engage with the latch to separate the opposite side of the access panel from the chassis in response to activating the latch to unlatch and open the access panel.

10. The device of claim 1 wherein the access panel is rectangular in shape and the walls extend along the hinged side of the access panel and includes an opening to allow the battery contacts to contact the circuitry contacts, and wherein the walls extend partially along two sides of the access panel extending toward an opposite side of the access panel, and wherein the circuitry contacts comprise push-pin contacts such that opening the access panel disconnects the battery contacts from the circuitry contacts.

11. The device of claim 1 wherein the latch comprises two spaced apart latches supported on the chassis opposite the hinge.

12. An electronic device comprising:
a chassis containing electrically powered circuitry, the chassis comprising:
a chassis cavity sized to contain a battery having a set of battery contacts;
a spring latch; and
a circuitry connector having circuitry contacts to electrically connect to the battery contacts and provide power to the electrically powered circuitry; and
an access panel coupled to the chassis by a hinge to selectively cover and expose the chassis cavity, the access panel comprising:
inverse chamfered walls to secure and register the battery and cause the battery contacts to engage the circuitry contacts with the access panel in a closed position secured by the spring latch.

13. The device of claim 12 wherein the inverse chamfered walls include a first inverse chamfered wall along a hinged side of the access panel and includes an opening to allow the battery contacts to contact the circuitry contacts.

14. The device of claim 12 wherein the circuitry contacts comprise push-pin contacts.

15. The device of claim 12 wherein the battery comprises a mylar cover shaped to fit the chassis cavity and the inverse chamfered walls.

16. The device of claim 12 wherein the chassis cavity conceals the electrically powered circuitry within the chassis while the chassis cavity is exposed.

17. The device of claim 12 wherein hinge comprises a compliant material rotatably coupling a hinged side of the access panel to the chassis.

18. The device of claim 12 wherein the access panel is rectangular in shape and the inverse chamfered walls extend along a hinged side of the access panel and partially along two sides of the access panel extending toward an opposite side of the access panel.

19. The device of claim 18 wherein the opposite side of the access panel is configured to mate with the spring latch in a closed position and wherein the opposite side of the access panel comprises a ramp to engage with the spring latch to separate the opposite side of the access panel from the chassis in response to activating the spring latch to unlatch and open the access panel.

20. The device of claim 12 wherein the access panel is rectangular in shape and the inverse chamfered walls extend along a hinged side of the access panel and includes an opening to allow the battery contacts to contact the circuitry contacts, and wherein the inverse chamfered wall extend partially along two sides of the access panel extending toward an opposite side of the access panel, and wherein the circuitry contacts comprise push-pin contacts such that opening the access panel disconnects the battery contacts from the circuitry contacts.
